(19) United States
(12) Patent Application Publication
(10) Pub. No.: US 2007/0192580 A1
(43) Pub. Date: Aug. 16, 2007

(54) Secure remote management of a TPM

(76) Inventors: David C. Challener, Raleigh, NC (US); Mark C. Davis, Durham, NC (US); Steven D. Goodman, Raleigh, NC (US); Isaac Karpel, Cary, NC (US); Randall S. Springfield, Chapel Hill, NC (US)

Correspondence Address: DILLION & YUDELL LLP, 8911 N. CAPITAL OF TEXAS HWY, SUITE 2110, AUSTIN, TX, 78759, US

(21) Appl. No.: 11/352,140

(22) Filed: Feb. 10, 2006

(51) Int. Cl. G06F 9/00; G06F 12/14; H04L 9/00; H04K 1/00; G06F 15/177; G06F 12/00; H04L 9/32; G06F 13/00; G06F 11/30; G06F 17/30; G06F 7/04; G06F 7/58; G06K 19/00; G11C 7/00

(52) U.S. Cl. 713/2; 713/176; 713/193; 713/164; 713/165; 713/167; 726/16; 713/182; 713/186

(57) ABSTRACT

A method, system and computer-usable medium are presented for remotely controlling a TPM by loading a trusted operating system into a computer; and in response to the trusted Operating System (OS) being loaded into the computer, authorizing a Trusted Platform Module (TPM) in the computer to execute a command that would otherwise require, for execution of the command, an indication of a physical presence of an operator of the computer.

### BACKGROUND OF THE INVENTION

1. Technical Field:

The present invention relates in general to the field of computers and similar technologies, and in particular to security features incorporated into such computers and technology.

2. Description of the Related Art:

While early computers were stand-alone units, modem computers rely on interconnectivity to other resources, such as other computers, storage devices, printers, etc., as a force multiplier. While such networking is advantageous, it presents the inherent security problems associated with any such resource sharing. In particular, such resource sharing creates the potential for sensitive data, such as credit card information, etc., to be snooped off the network by nefarious parties. To combat this problem, numerous security schemes, which are known to those skilled in the art of computer security, have been developed. Such security schemes include the use of passwords, keys and digital certificates.

Passwords are single keys, which usually are in the form of an alpha-numeric word. For example, to open a document or to access a database, a user must type in a string of alpha-numeric characters. Passwords are obviously useful only for limited users.

Digital certificates are values that provide authentication in an electronic document. Typically, the authentication is the result of the following steps. First, a first hash (a value obtained by applying a specific algorithm to the electronic document) of the electronic document is created by a sender of the electronic document. Second, a clear version of the electronic document is sent to a receiver, along with the first hash. Then, using the same specific algorithm used by the sender, the receiver hashes the clear version of the electronic document to create a second hash. If the first and second hashes are the same, then the receiver can assume that the electronic document is authentic and uncorrupted. (Note that a hash cannot be reverse engineered to obtain a true copy of electronic document.) Unlike passwords, digital signatures are useful when many users are involved in communication, since the hash algorithm can be obtained by any authorized party through a third party authority.

Keys are encryption keys, which typically come in public/private pairs, which are typically issued by a third-party Certification Authority (CA). Data that is encrypted by the public key can only be decrypted by the private key in the public/private key pair. Similarly, data that is encrypted by the private key can only be decrypted by the public key in the public/private key pair.

Passwords, digital certificates, keys and like security data/routines may be stored in a Trusted Platform Module (TPM) chip in a computer. The Trusted Platform Module (TPM) specification is described in the Trusted Computing Platform Alliance (TCPA) Main Specification Version 1.1b et seq., published by the Trusted Computing Group (TCG) in 2003 et seq., and more specifically in the TPM Main Part 2 TPM Structures, version 1.2, published 13 Feb. 2005 by TCG, which are herein incorporated by reference in their entirety.

The TPM chip (also known simply as “TPM”)is a microcontroller, which as stated above, stores passwords, digital certificates, keys and like security data. The TPM is typically attached to a motherboard of a computer, such as a personal computer. One feature of TPM, found in Section 2.7 of the TCPA Mail Specification, is that a “physical presence” of an operator must be detected in order for the TPM to be accessed for certain operations. Such operations include clearing a user's stored cryptographic keys and returning the TPM to its initial state (i.e., the state when it left the manufacturing floor). This physical presence may be detected by a mechanical engagement of a manual device such as a reset switch or a jumper switch, either of which require the physical presence of a user to manually activate the switch.

Determining whether a user's physical presence is required for an operation comes under the purview of a Core Root of Trust for Measurement (CRTM) function within a Trusted Computing Group (TCG) compliant Basic Input/Output System (BIOS). The TCG compliant BIOS determines if a user (operator) is physically present, and then communicates the operator's presence to the TPM. Once the presence or absence of the physical operator has been established and communicated to the TPM, the state of the operator's presence is locked to prevent it from changing until a next BIOS boot.

While the feature of requiring a user's physical presece prevents remote hacking into the TPM chip, which is advantageous, it also prevents authorized remote control of the TPM chip, which is disadvantageous.

### SUMMARY OF THE INVENTION

To address the need for a method for establishing an environment where TPM can be remotely accessed, a method, system and computer-usable medium are presented for remotely controlling a TPM by loading a trusted operating system into a computer; and in response to the trusted Operating System (OS) being loaded into the computer, authorizing a Trusted Platform Module (TPM) in the computer to execute a command that would otherwise require, for execution of the command, an indication of a physical presence of an operator of the computer.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer in which the present invention may be implemented;

FIG. 2 is a flow-chart of steps taken in the present invention to manipulate a Trusted Platform Module (TPM) in the computer shown in FIG. 1 when a Core Root of Trust for Measurement (CRTM) in a Basic Input/Output System (BIOS) encompasses an entire Power On Self Test (POST) in the BIOS; and

FIGS. 3a-b show a flow-chart of steps taken in the present invention to manipulate the TPM in the computer shown in FIG. 1 when the CRTM is confined to a bootblock in the BIOS.

### DETAILED DESCRIPTION OF THE PREFERRED EMBODIMENT

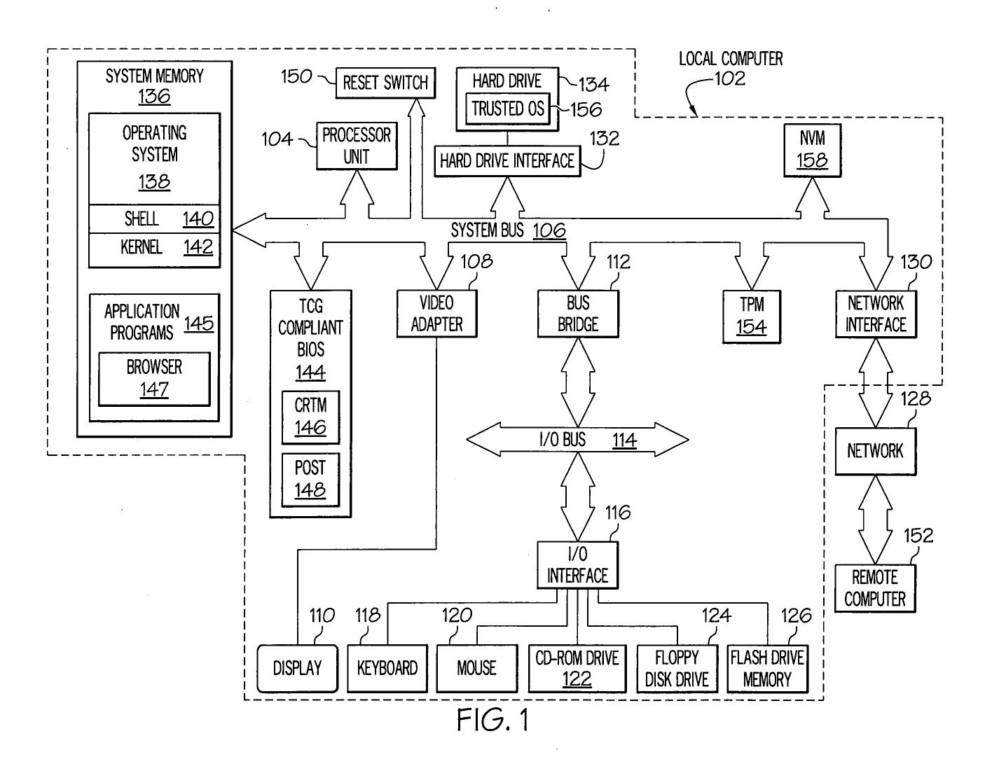

With reference now to the figures, and in particular to FIG. 1, an exemplary local computer 102 in which the present invention may be implemented is presented. Local computer 102 includes processor unit 104, which preferably includes multiple processors organized into a multi-processor architecture, which is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/0 interface 116 affords communication with various I/O devices, including a keyboard 118, a mouse 120, a Compact Disk—Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Local computer 102 is able to communicate with a remote computer 152 via a network 128 using a network interface 130, which is coupled to system bus 106. Network 128 may be an external network such as the Internet, or an internal network such as an Ethernet or a Virtual Private Network (VPN). As stated, using network 128, client computer 102 is thus able to access remote computer 152, which may be a server relative to (client) local computer 102. This allows an administrator, management agent, etc. to use remote computer 152 to control the use of a Trusted Platform Module (TPM) 154, whose function is described below, in a manner described according to the present invention.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes local computer 102's operating system (OS) 138, which as described below may be a trusted OS 156, which may be located in hard drive 134 or any other location deemed appropriate in light of the present invention. Also coupled to system bus 106 is a Trusted Computing Group (TCG) compliant Basic Input/Output System (BIOS) 144, which includes a Core Root of Trust for Measurement (CRTM) 146 as well as a Power On Self Test (POST) 148. One function of CRTM 146 is to determine if an operator is physically present (as indicated, e.g., by a reset switch 150 being manually depressed), and then communicating this physical presence (of the operator) to Trusted Platform Module (TPM) 154 (described below). In a preferred embodiment of the present invention, CRTM 146 is altered to be able to also establish if there is a request to load trusted OS 156, and to establish that the OS 138 that is loaded into system memory 136 is actually trusted OS 156.

OS 138 also includes a shell 140, for providing transparent user access to resources such as application programs 145. Generally, shell 140 is a program that provides an interpreter and an interface between the user and the operating system. More specifically, shell 140 executes commands that are entered into a command line user interface or from a file. Thus, shell 140 (as it is called in UNIX®, also called a command processor in Windows®), is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 145, including memory management, process and task management, disk management, and mouse and keyboard management.

Application programs 145 include a browser 147. Browser 147 includes program modules and instructions enabling a World Wide Web (WWW) client (i.e., local computer 102) to send and receive network messages to the Internet using HyperText Transfer Protocol (HTTP) messaging, thus enabling communication with remote computer 152.

As depicted, also coupled to system bus 106 is Trusted Platform Module (TPM) 154. As described above, TPM 154 is a microcontroller that stores passwords, digital certificates, encryption/decryption keys and like security data, in compliance with the (TPM) specification described in the Trusted Computing Platform Alliance (TCPA) Main Specification Version 1.1b et seq., published by the Trusted Computing Group (TCG) in 2003 et seq., and more specifically in the TPM Main Part 2 TPM Structures, version 1.2, published 13 Feb. 2005 by TCG. Both specifications are herein incorporated by reference in their entirety, and together are referred to as the “TCG standard”.

Also coupled to system bus 106 is a Non-Volatile Memory (NVM) 158, which, for example, may be a CMOS, EEPROM, etc., and is used to store data in a non-volatile manner.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention. Note further that some or all of the components depicted for local computer 102 may be utilized in the architecture of remote computer 152.

As noted above, CRTM 146 establishes (1) that there is a request to load trusted OS 156, and subsequently establishes (2) that the OS 138 that is loaded into system memory 136 is actually the trusted OS 156. Once both of these items have been established, CRTM 146 can safely indicate to TPM 154 that the requirements for operator physical presence have been met, and indicate to TPM 154 that TPM commands requiring physical presence are to be accepted for execution. If either item (1) or (2) are not established, then CRTM 146 reverts back to the requirement that an actual physical presence be detected (e.g., the manual depression of reset switch 150) before certain TPM commands are accepted and executed by TPM 154.

How CRTM 146 determines that trusted OS 156 is to be loaded depends on how CRTM 146 is implemented and how a user/operator indicates that a trusted OS load is desired. Consider now the following characteristic features of CRTM 146. The TCG standard requires CRTM 146 to be contained in the first code that executes when a computer system is reset. It is the manufacturer's decision on whether to designate CRTM 146 to be contained in the first code that executes when a computer system is reset (e.g., in the bootblock). The bootblock is defined as a small part of the BIOS that contains recovery function to restore the main portion of BIOS/POST should the main portion of the BIOS/POST be corrupted. When a computer is powered-up or reset, the Basic Input/Output System (BIOS) performs initial tests of the computer system before transferring control to the Master Boot Record (MBR).

Since CRTM 146 is the root of the trust chain, the TCG standard requires special protection for CRTM 146. This in turn leads to restrictions that complicate the ability to update BIOS 144 if the entire BIOS 144 is designated as the CRTM 146. For this reason, the most common implementation is for the CRTM 146 to be implemented as part of the bootblock, thus permitting most of the POST/BIOS to be freely updated as long at the bootblock is protected. This special protection for the bootblock does not impose an unreasonable restriction since the bootblock is normally not updated as part of a POST/BIOS update. While this implementation creates other difficulties, such as requiring an establishment of physical presence (of the operator) or additional measurement of the POST code (per the TCG standard), the flexibility of being able to freely update the main part of POST/BIOS more than compensates for the additional complexity.

In an environment in which the CRTM is the entire POST, determining that a secure OS is to be loaded and delaying the physical presence decision is straight forward. The POST code simply queries a flag (which can be set by POST as a result of a user pressing a key, or it could be set by a program on a previous boot to request a trusted OS be booted to provide some service) in NVM 158. If the flag is set to indicate that trusted OS 156 is to be loaded, POST 148 will find trusted OS 156 on the boot media (e.g., the hard disk in hard drive 134, a CDROM, a PXE boot, etc.) and load the OS into system memory 136. Before transferring control to trusted OS 156, POST will verify trusted OS 156 by performing a signature (using a key stored in BIOS 144 or NVM 158) check of the OS 138 that was just loaded into system memory 136. If the signature is correct, the CRTM/POST will indicate to the TPM 154 that “physical presence” (of the operator) has been established and transfer control to (now loaded) trusted OS 156. If the signature check fails, POST 148 will indicate that physical presence is not established and lock that setting (“no physical presence established ”) in TPM 154 to prevent an untrusted OS from establishing physical presence. If the POST flag indicates that a trusted OS is not requested, then POST 148 simply establishes physical presence in a traditional manner (e.g., detecting a manual engagement of reset switch 150).

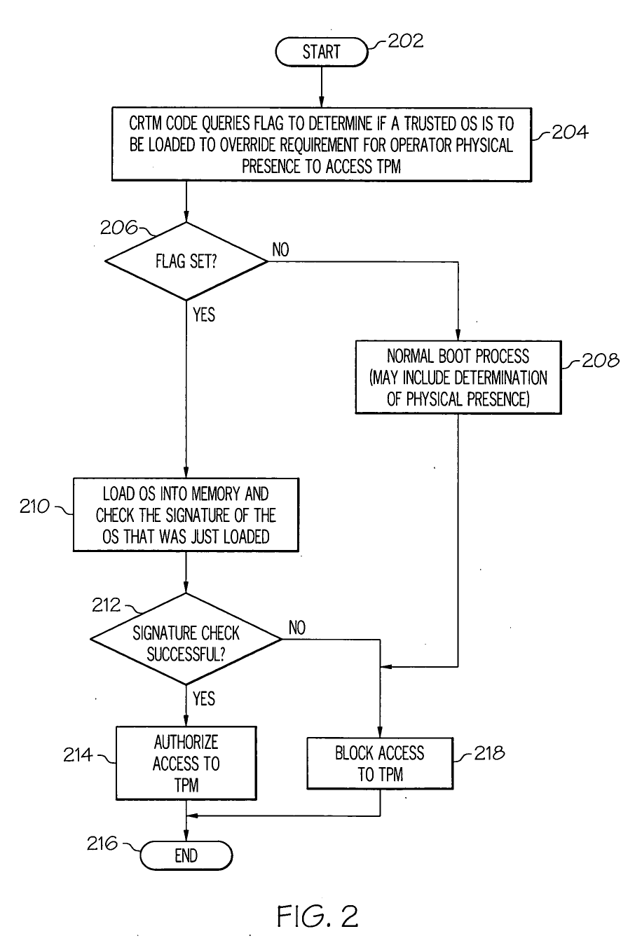

Referring now to FIG. 2, an overview of the procedure just described is presented as a flow-chart. After initiator block 202, CRTM code queries a flag to determine if a trusted OS is to be loaded, thus overriding a requirement for the operator to take some physical step to establish his physical presence, as required by the TPM (block 204). If such a flag is not set (query block 206), then the CRTM follows the usual boot process (block 208), which may include the requirement of the detection of an operator's physical presence to permit use of privileged commands within the POST process. Upon completion of the normal POST process, the CRTM must indicate that further acceptance of privileged commands is not allowed (Block 218). Returning to query block 206, if the flag is set, then the CRTM/POST/BIOS loads the OS and performs a signature check of the OS that was loaded (Block 210). If the signature check is successful, (query block 212), control is transferred to block 214, where the TPM is authorized to execute commands that require physical presence. Finally, the process terminates at terminator block 216, where control is transferred to the OS that was loaded. If, at query block 212, the signature check is found to have failed, the control is transferred to block 218, where the CRTM indicates that execution of commands requiring physical presence is not permitted.

If CRTM 146 is confined to the bootblock, the process of accessing TPM 154 is more complex. In this case, CRTM 146 must determine the physical presence well before it is possible to determine the validity of the OS that is to be loaded. In this environment, the CRTM 146 is extended to include the entire POST 148. One way to do this is to perform a signature check of the entire BIOS 144. If the signature check is successful (indicating that POST 148 is to be trusted), then CRTM 146 can trust POST 148 to determine the validity of the OS and set the physical presence appropriately.

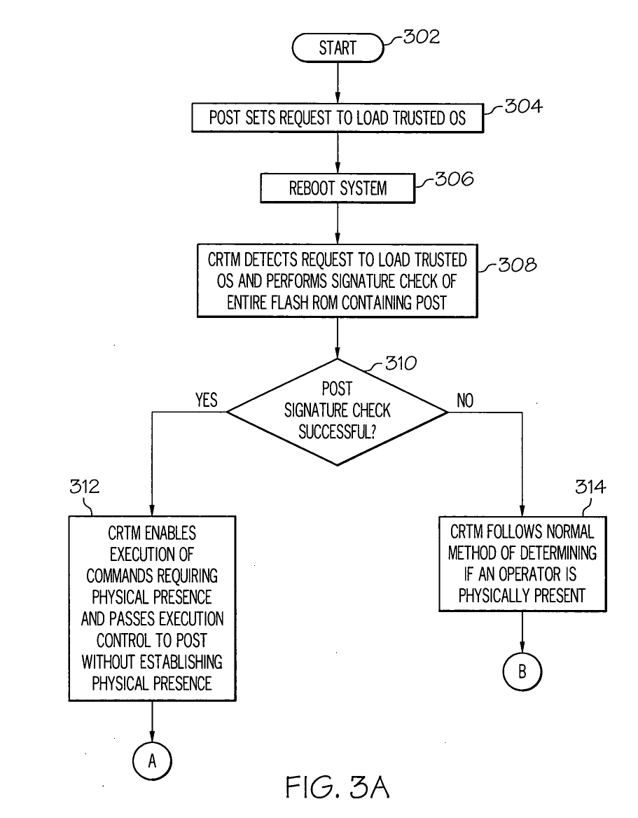

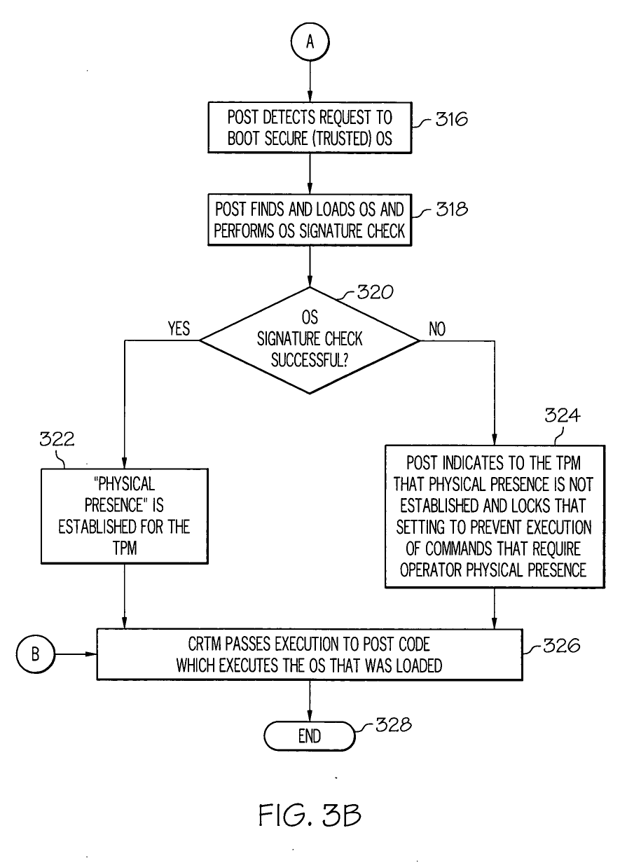

Referring then to FIGS. 3a-b, which depict the process in which CRTM is confined to the bootblock, the process begins at initiator block 302. POST (or a previous program) sets a request to load a trusted OS (block 304). The system is then rebooted (block 306), which is required even in POST since the CRTM may have already established that there is no physical presence and locked the setting. The CRTM detects a request to load a trusted OS (block 308), and performs a signature check of all of POST 148 (in a flash ROM). If the POST signature check is successful (query block 310), then the CRTM indicates to the TPM that execution of commands requiring physical presence is permitted and passes execution control to POST 148 without establishing actual physical presence (e.g., manual depression of a reset button), as described in block 312. However, if the POST signature fails, then CRTM follows it's normal method of determining if an operator is physically present (e.g. depression of switch, moved jumper, etc.). Thereafter, CRTM passes execution to the POST code as normal, such that the POST executes the OS that was just loaded (or prerequisitely loads an OS if an OS has not already been loaded), as described in FIG. 3b at block 326.

Referring again to FIG. 3a, after the action described in block 312 transpires, POST detects a request to boot a secure OS (as shown in FIG. 3b at block 316). POST finds and loads the trusted OS and performs a signature check on that OS (block 318) to ensure that the trusted OS is not corrupted. If the OS signature is successful (query block 320), then the “physical presence” is established (block 322), and POST informs the TPM that there is operator physical presence. When POST then proceeds to execute the OS (block 326), TPM is available for executing operations that require operator physical presence, and the process ends (terminator block 328). If, however, the OS signature is not successful (query block 320), then POST indicates to the TPM that physical presence is not established and locks that setting to prevent execution of commands that require operator physical presence (block 324) before proceeding to block 326.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
loading a trusted operating system into a computer; and
in response to the trusted Operating System (OS) being loaded into the computer, authorizing a Trusted Platform Module (TPM) in the computer to execute a command that would otherwise require, for execution of the command, an indication of a physical presence of an operator of the computer.

2. The method of claim 1, wherein the authorizing of the TPM to execute a command is performed by a Core Root of Trust for Measurement (CRTM) in a Basic Input/Output System (BIOS) in the computer, and wherein the authorizing step further comprises:
detecting that the trusted OS is to be loaded into the computer; and
delaying a decision to detect the physical presence of the operator until after the trusted OS is loaded into the computer, wherein the physical presence of the operator is not required for remote access to the TPM.

3. The method of claim 1, wherein the CRTM is confined to a bootblack in the BIOS, and wherein the method further comprises:
setting a request to load the trusted OS by a Power On Self Test (POST) program in the computer, wherein the CRTM detects a request to load the trusted OS subsequent to a system reboot in the computer.

4. The method of claim 3, further comprising:
performing a signature check of the entire POST; and
utilizing a successful signature check of the entire POST to establish the physical presence of the operator.

5. The method of claim 3, further comprising:
performing a signature check of the entire POST; and
utilizing an unsuccessful signature check of the entire POST to establish a need for an actual physical presence of the operator to implement an operation in the TPM that requires the physical presence of the operator.

6. The method of claim 3, further comprising:
detecting by the POST program a request to boot the trusted OS;
loading the trusted OS into a system memory in the computer;
performing a signature check of the trusted OS to ensure that the trusted OS is not corrupted; and
in response to the signature check confirming that the trusted OS is not corrupted, establishing a fictional physical presence, wherein TPM commands that require an actual physical presence of an operator can be accessed and executed.

7. A system comprising:
a processor;
a data bus coupled to the processor;
a memory coupled to the data bus; and
a computer-usable medium embodying computer program code, the computer program code comprising instructions executable by the processor and configured for:
loading a trusted operating system into a computer; and
in response to the trusted Operating System (OS) being loaded into the computer, authorizing a Trusted Platform Module (TPM) in the computer to execute a command that would otherwise require, for execution of the command, an indication of a physical presence of an operator of the computer.

8. The system of claim 7, wherein the authorizing of the TPM to execute a command is performed by a Core Root of Trust for Measurement (CRTM) in a Basic Input/Output System (BIOS) in the computer, and wherein the instructions are further configured for:
detecting that the trusted OS is to be loaded into the computer; and
delaying a decision to detect the physical presence of the operator until after the trusted OS is loaded into the computer, wherein the physical presence of the operator is not required for remote access to the TPM.

9. The system of claim 7, wherein the CRTM is confined to a bootblock in the BIOS, and wherein the instructions are further configured for:
setting a request to load the trusted OS by a Power On Self Test (POST) program in the computer, wherein the CRTM detects a request to load the trusted OS subsequent to a system reboot in the computer.

10. The system of claim 9, wherein the instructions are further configured for:
performing a signature check of the entire POST; and
utilizing a successful signature check of the entire POST to establish the physical presence of the operator.

11. The system of claim 9, wherein the instructions are further configured for:
performing a signature check of the entire POST; and
utilizing an unsuccessful signature check of the entire POST to establish a need for an actual physical presence of the operator to implement an operation in the TPM that requires the physical presence of the operator.

12. The system of claim 9, wherein the instructions are further configured for:
detecting by the POST program a request to boot the trusted OS;
loading the trusted OS into a system memory in the computer;
performing a signature check of the trusted OS to ensure that the trusted OS is not corrupted; and
in response to the signature check confirming that the trusted OS is not corrupted, establishing a fictional physical presence, wherein TPM commands that require an actual physical presence of an operator can be accessed and executed.

13. A computer-usable medium embodying computer program code, the computer program code comprising computer executable instructions configured for:
loading a trusted operating system into a computer; and
in response to the trusted Operating System (OS) being loaded into the computer, authorizing a Trusted Platform Module (TPM) in the computer to execute a command that would otherwise require, for execution of the command, an indication of a physical presence of an operator of the computer.

14. The computer-usable medium of claim 13, wherein the authorizing of the TPM to execute a command is performed by a Core Root of Trust for Measurement (CRTM) in a Basic Input/Output System (BIOS) in the computer, and wherein the instructions configured for said authorizing step further comprise instructions configured for:
detecting that the trusted OS is to be loaded into the computer; and
delaying a decision to detect the physical presence of the operator until after the trusted OS is loaded into the computer, wherein the physical presence of the operator is not required for remote access to the TPM.

15. The computer-usable medium of claim 13, wherein the CRTM is confined to a bootblock in the BIOS, and wherein the instructions are further configured for:
setting a request to load the trusted OS by a Power On Self Test (POST) program in the computer, wherein the CRTM detects a request to load the trusted OS subsequent to a system reboot in the computer.

16. The computer-usable medium of claim 15, wherein the instructions are further configured for:
performing a signature check of the entire POST; and
utilizing a successful signature check of the entire POST to establish the physical presence of the operator.

17. The computer-usable medium of claim 15, wherein the instructions are further configured for:
performing a signature check of the entire POST; and
utilizing an unsuccessful signature check of the entire POST to establish a need for an actual physical presence of the operator to implement an operation in the TPM that requires the physical presence of the operator.

18. The computer-usable medium of claim 15, wherein the instructions are further configured for:
detecting by the POST program a request to boot the trusted OS;
loading the trusted OS into a system memory in the computer;
performing a signature check of the trusted OS to ensure that the trusted OS is not corrupted; and
in response to the signature check confirming that the trusted OS is not corrupted, establishing a fictional physical presence, wherein TPM commands that require an actual physical presence of an operator can be accessed and executed.
